(19) United States
(12) Patent Application Publication
(10) Pub. No.: US 2012/0087714 A1
(43) Pub. Date: Apr. 12, 2012

(54) FILE FOLDER

(76) Inventor: Jui-Lin CHANG, Taichung County (TW)

(21) Appl. No.: 12/902,515

(22) Filed: Oct. 12, 2010

(51) Int. Cl. B42F 13/00

(52) U.S. Cl. 402/73

(57) ABSTRACT

A file folder includes an external layer, an internal layer, and a laminate encapsulated between the external and internal layers. The laminate includes a top wall, a bottom wall, and a plurality of arc-shaped support members connected between the top and bottom walls. A specific value of a thickness of the laminate to a pitch between the support members is larger than or equal to 0.8. Accordingly, the file folder is lightweight and structurally strong.

### BACKGROUND OF THE INVENTION

1. Field of the Invention

The present invention relates generally to stationery, and more particularly, to a file folder.

2. Description of the Related Art

There are a variety of conventional file folders, e.g. a file folder made of a folded cardboard or a folded plastic board, but they are neither structurally strong nor durable. To enhance the structural strength and durability of the file folder, a multi-layer file folder composed of an external jacket, an internal jacket, and an intermediate structural panel adhesively mounted between the external and internal jackets was proposed. The intermediate structural panel is usually made of paperboard, foam material, or solid plastic board. Although the paperboard can enhance the structural strength of the file folder, it makes the file folder heavy and be subject to deformation and adsorption of damp. The foam material is though lightweight, but its structural strength is insufficient. The plastic board is though structurally strong and not absorptive of damp but too heavy. Besides, the aforesaid external jacket, internal jacket, and intermediate structural panel are made of different materials separately, such that they need to be separated, before they are further processed in a recycling process, resulting in inconvenience.

### SUMMARY OF THE INVENTION

The primary objective of the present invention is to provide a file folder, which is structurally strong and lightweight.

The foregoing objective of the present invention is attained by the file folder composed of an external layer, an internal layer, and a laminate encapsulated between the external and internal layers. The laminate includes a top wall, a bottom wall, and a plurality of arc-shaped support members connected between the top and bottom walls in such a way that a plurality of hollow portions are formed therebetween. Because the laminate is structurally hollow and the support members are curvedly and nonlinearly arranged between the top and bottom walls, the file folder is not only structurally strong but also lightweight.

Besides, the distance between the top and bottom walls ranges preferably from 1.5 mm to 3.5 mm and more preferably from 2.5 mm to 3.5 mm. The specific value of the distance between the top and bottom walls to the pitch between each two adjacent support members is preferably larger than or equal to 0.8 and more preferably, larger or equal to than 1. In this way, the laminate has preferable resistance against an external force perpendicular to the top and bottom walls, so it has sufficient structural strength not to be easily bendable.

In the file folder of the present invention, the arc-shaped support members may extend transversally from the left side to the right side of the laminate or longitudinally extend from the upside to the downside of the laminate.

According to the file folder of a preferred embodiment of the present invention, each of the internal and external layers includes a left section, a right section, and a middle section connected between the left and right sections. The laminate has a left panel encapsulated between the left sections of the internal and external layers, a right panel encapsulated between the right sections of the internal and external layers, and a middle panel encapsulated between the middle sections of the internal and external layers. The support members of the left and right panels extend transversally, and the support members of the middle panel extend longitudinally.

In another preferred embodiment of the present invention, the support members of the left, right and middle panels extend longitudinally.

Another objective of the present invention is to provide a file folder, which can be recycled conveniently.

To attain the above-mentioned objective, the internal and external layers and the laminate are made of a same material including but not limited to polypropylene or polyethylene, such that the internal and external layers and the laminate need not to be separated in advance in a recycling process.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below and the accompanying drawings which are given by way of illustration only, and thus are not limitative of the present invention, and wherein:

FIG. 1 is a perspective view of a file folder according to a first preferred embodiment of the present invention, in which the internal layer is partially separated from the external layer and partially cutaway for illustrative purpose;

FIG. 2 is an enlarged perspective view of a part of the laminate of the file folder of the first preferred embodiment of the present invention;

FIG. 3 is a schematic drawing showing the definitions of distance between the top and bottom walls and the pitch between the support members, and

FIG. 4 is a perspective view of a file folder according to a second preferred embodiment of the present invention, in which the internal layer is partially separated from the external layer and partially cutaway for illustrative purpose.

### DETAILED DESCRIPTION OF PREFERRED EMBODIMENTS

First of all, it is to be noted that the same reference sign used in the following description indicates the same or similar element or structural feature.

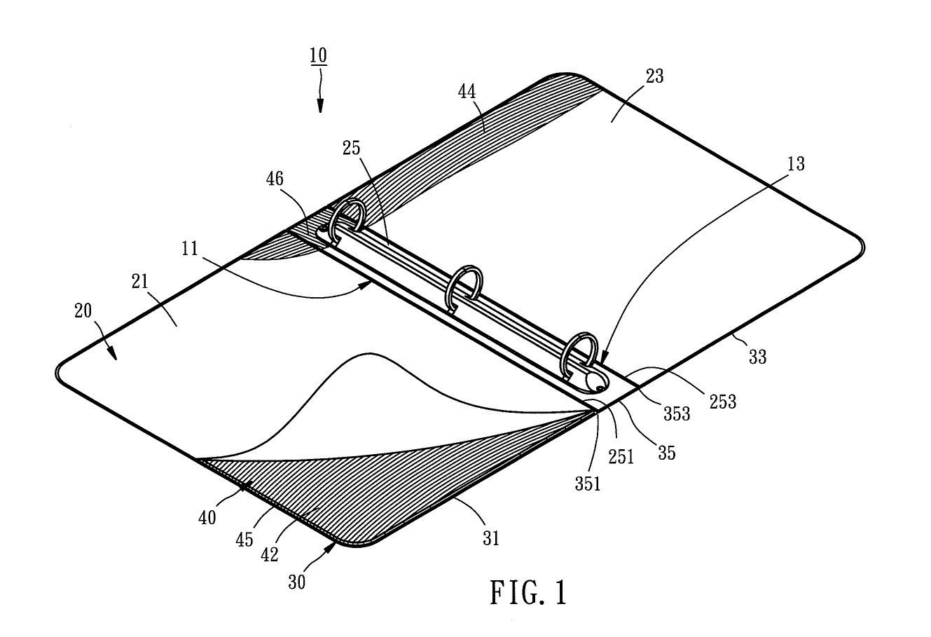

Referring to FIG. 1, a file folder 10 constructed according to a first preferred embodiment of the present invention is composed of an internal layer 20, an external layer 30, and a laminate 40. The detailed descriptions and operations of these elements as well as their interrelation are recited in the respective paragraphs as follows.

Each of the internal and bottom layers 20 and 30 is made of polypropylene (PP) or polyethylene (PE) and includes a left section 21(31), a right section 23(33), and a middle section 25(35) connected between the left and right sections 21(31) and 23(33). A left folded line 251(351) is provided at the left side of the middle section 25(35) for joint with the left section 21(31) in one piece, and a right folded line 253(353) is provided at the right side of the middle section 25(35) for joint with the right section 23(33). In this way, the left sections 21 and 31 can be folded rightward on the left folded line 251 and 351 and the right sections 23 and 33 can be folded leftward on the right folded line 253 and 353.

In the process of production, peripheral edges of the internal and external layers 20 and 30 can be jointed with each other by, for example, hot pressing, to fully encapsulate the laminate 40 without exposure of the laminate 40. Besides, the left folded line 251 of the internal layer 20 can be jointed with the left folded line 351 of the external layer 30 by hot pressing to become a left crease 11 of the file folder 10, and the right folded line 253 of the internal layer 20 can be jointed with the right folded line 353 of the external layer 30 by hot pressing to become a right crease 13 of the file folder 10.

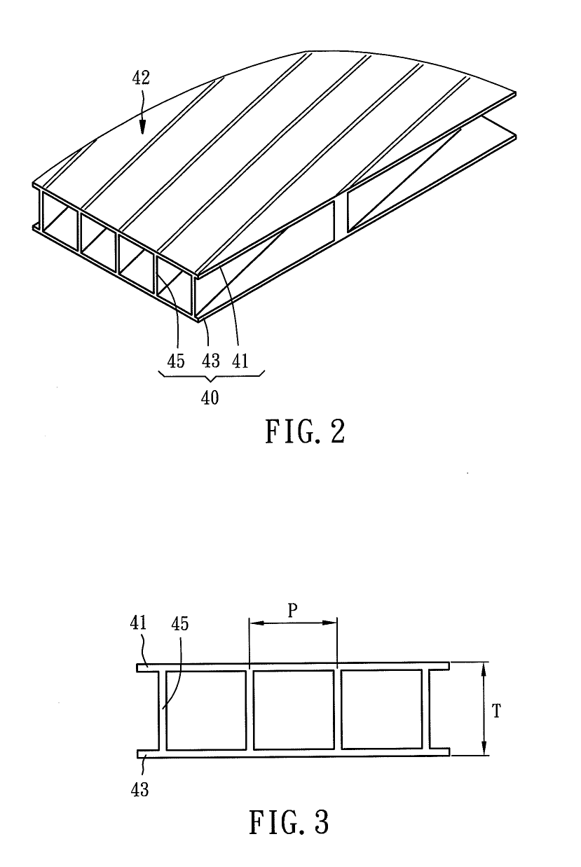

The laminate 40 is a translucent extrusion-molding sheet made of a material same as the material that the internal and external layers 20 and 30 are made of. As shown in FIG. 2, the laminate 40 includes a top wall 41, a bottom wall 43, and a plurality of arc-shaped support members 45 connected with the top and bottom walls 41 and 43 and separated from each other at a same pitch. As shown in FIG. 1, the laminate 40 in this embodiment is composed of a left panel 42, a right panel 44, and a middle panel 46. The arc-shaped support members 45 of the left and right panels 42 and 44 extend parallel transversally between respective left and right sides of the panel; those of the middle panel extend parallel longitudinally between the topside and downside of the middle panel. As shown in FIG. 3, the distance between the top and bottom walls 41 and 43 of the laminate 40, i.e. the thickness (T) of the laminate 40, is preferably in a range of 1.5-3.5 mm and more preferably in a range of 2.5-3.5 mm. The pitch (P) between each two adjacent support members 45 is preferably in a range of 1.5-3.5 mm and preferably in a range of 2.5-3.5 mm. Besides, the specific value of the thickness to the pitch, i.e. T/P value, is preferably larger than or equal to 0.8 and more preferably, larger than or equal to 1, such that the laminate 40 can provide a sufficient structural strength along a direction orthogonal to the top and bottom walls 41 and 43 so as to thus prevent the laminate 40 from bending deformation resulting from overlong span between the support members 45.

In production, the left panel 42 is inserted into and fully encapsulated between the left sections 21 and 31 of the internal and external layers 20 and 30. The right panel 44 is inserted into and fully encapsulated by the right sections 23 and 33 of the internal and external layers 20 and 30. The middle panel 46 is inserted into and fully encapsulated between the middle sections 25 and 35 of the internal and external layers 20 and 30.

When using a general file folder, a user usually applies an improper force to the left and right sections, resulting in undesired creases on the left and right section of the conventional file folder. However, in the present invention, the support members 45 of the left and right panels 42 and 44 extend curvedly and transversally to provide a good structural supporting force for the whole file folder to counteract the user's improper force and to avoid any longitudinal linear crease on the left and right panels 42 and 44. In other words, the file folder 10 of the present invention has preferable structural strength and is not subject to improper bending deformation of the left and right panels 42 and 44 resulting from the frequent opening and closing actions of the file folder 10 or the user's improper force. In addition, the laminate 40 includes a plurality of the hollow portions formed between each two adjacent support members 45, such that the file folder 10 is lightweight. Further, the support members 45 of the middle panel 46 are arc-shaped and extend nonlinearly longitudinally, such that the improper bending deformation of the file folder can be avoided.

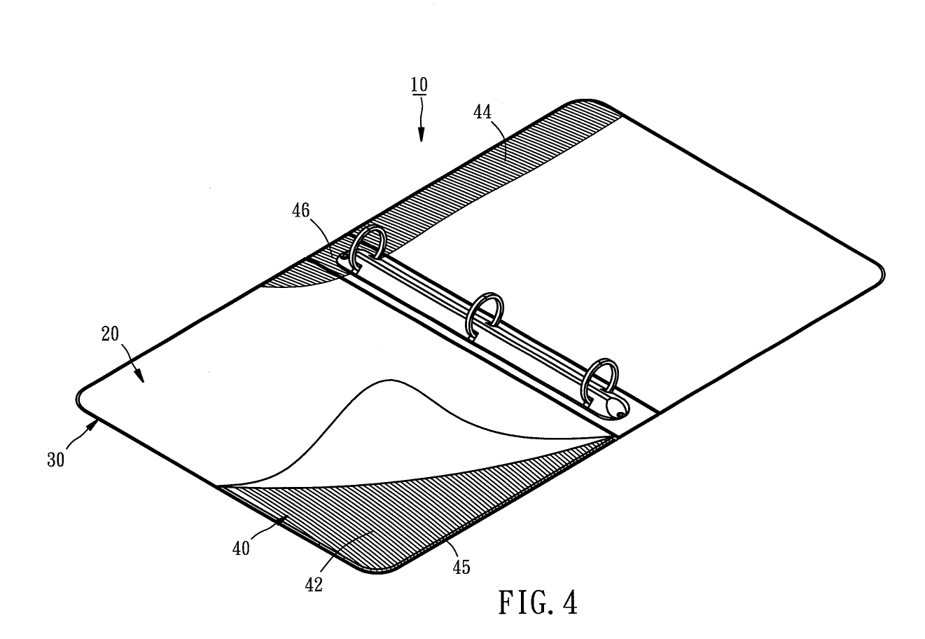

It will be appreciated that where the support members 45 of the present invention extend is not limited to the aforesaid ones. For example, FIG. 4 illustrates the file folder 10 of a second preferable embodiment, in which the file folder 10 likewise includes an internal layer 20, an external layer 30, and a laminate 40. In this embodiment, the arc-shaped support members 45 of the left, right, and middle panels 42, 44 and 46 extend longitudinally to attain the same objective of the present invention.

In conclusion, the laminate of the present invention is of multiple hollow portions and the support members forming the hollow portions are arc-shaped not linear, such that structural strength of the file folder can be enhanced and the file folder can be lightweight. Besides, the internal and external layers and the laminate each are made of the same material, PP or PE, so the file folder of the present invention can be processed in a recycling as a whole, which needs not to separate the internal and external layers and the laminate in advance for recycling processing.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A file folder, comprising:
an internal layer;
an external layer; and
a laminate encapsulated by the internal and external layers and having a top wall, a bottom wall, and a plurality of arc-shaped support members connected with the top and bottom walls;
wherein the laminate has a thickness ranging from 1.5 mm to 3.5 mm; a pitch ranging from 1.5 mm to 3.5 mm is provided between the support members; a specific value of the thickness of the laminate to the pitch between the support members is larger than or equal to 0.8.

2. The file folder as defined in claim 1, wherein the support members extend transversally between left and right sides of the laminate.

3. The file folder as defined in claim 1, wherein the support members extend longitudinally between an upside of the laminate and a downside of the laminate.

4. The file folder as defined in claim 1, wherein each of the internal and external layers comprises a left section, a right section, and a middle section connected between the left and right sections; the laminate comprises a left panel encapsulated between the left sections of the internal and external layers, a right panel encapsulated between the right sections of the internal and external layers, and a middle panel encapsulated between the middle sections of the internal and external layers; the support members of the left and right panels extend transversally, and the support members of the middle panel extend longitudinally.

5. The file folder as defined in claim 4, wherein the internal and external layers and the laminate are made of polypropylene.

6. The file folder as defined in claim 4, wherein the internal and external layers and the laminate are made of polyethylene.

7. The file folder as defined in claim 1, wherein each of the internal and external layers comprises a left section, a right section, and a middle section connected between the left and right sections; the laminate comprises a left panel encapsulated between the left sections of the internal and external layers, a right panel encapsulated between the right sections of the internal and external layers, and a middle panel encapsulated between the middle sections of the internal and external layers; the support members of the left, right and middle panels extend longitudinally.

8. The file folder as defined in claim 7, wherein the internal and external layers and the laminate are made of polypropylene.

9. The file folder as defined in claim 7, wherein the internal and external layers and the laminate are made of polyethylene.
